(19) United States
(12) Patent Application Publication
(10) Pub. No.: US 2018/0159310 A1
(43) Pub. Date: Jun. 7, 2018

(54) ARC FAULT CIRCUIT INTERRUPTER APPARATUS AND METHODS USING SYMMETRICAL COMPONENT HARMONIC DETECTION

(71) Applicant: Eaton Corporation, Cleveland, OH (US)

(72) Inventor: Yi Yang, Milwaukee, WI (US)

(21) Appl. No.: 15/368,175

(22) Filed: Dec. 2, 2016

(51) Int. Cl. H02H 3/16; H02H 3/04

(52) U.S. Cl. CPC H02H 3/16; H02H 3/04

(57) ABSTRACT

Methods include sensing phase currents through a circuit interruption device, generating at least one symmetrical component harmonic current signal for at least one harmonic of the phase currents responsive to the sensed phase currents, and interrupting the phase currents responsive to the at least one symmetrical component harmonic current signal. The phase currents may be interrupted responsive to a phase and/or a magnitude of the at least one symmetrical component harmonic current signal meeting a criterion. The at least one harmonic may include at least one odd harmonic, such as at least one of a third harmonic and a fifth harmonic. The at least one symmetrical component harmonic current signal may include a positive sequence harmonic current signal and/or a negative sequence harmonic current signal.

### BACKGROUND

The inventive subject matter relates to circuit interrupter apparatus and methods and, and, more particularly, to apparatus and methods for interrupting arc faults.

A wide variety of different types of circuit interruption devices are used in electrical power distribution systems. Arc fault circuit interruption (AFCI) devices have been developed to provide protection against arc faults, which are intermittent high impedance faults that can be caused by such things as worn insulation, loose connections, and broken conductors.

An arc fault involves an energy release that occurs during a dielectric breakdown in air surrounding two live conductors. The resulting ionized plasma between the conductors essentially causes a short circuit electrical fault, which has the potential to cause significant damage to electrical switchgear and distribution equipment and can harm or kill persons in proximity to the fault. Deteriorating insulation is a leading cause of arc-producing electrical failures.

In a commercial or industrial electrical distribution network (a secondary network), voltages are typically significantly higher than those in a residential setting. Consequently, arc faults in these applications may release more energy and potentially cause catastrophic equipment failures. Therefore, effective detection and protection of arc faults in commercial/industrial electrical distribution networks is particularly important because of the higher potential for damage and/or injury.

In residential Arc Fault Circuit Interrupters (AFCI), where low cost is particularly important, arc faults are typically detected by sensing conducted broadband high frequency noise generated by an arcing fault. However, industrial facilities can be very high ambient electromagnetic interference (EMI) environments, which can cause traditional AFCIs to nuisance trip. Insulation integrity/impedance measurements (e.g., partial discharge, Hi-Pot, megger testing, etc.) can be effective in predicting failures and arc faults, but typically have a higher cost for detection, instrumentation, and analysis, and may only provide intermittent offline testing.

### SUMMARY

Some embodiments of the inventive subject matter provide methods of operating a circuit interruption device. The methods include sensing phase currents through the circuit interruption device, generating at least one symmetrical component harmonic current signal for at least one harmonic of the phase currents responsive to the sensed phase currents, and interrupting the phase currents responsive to the at least one symmetrical component harmonic current signal. Interrupting the phase currents responsive to the at least one symmetrical component harmonic current signal may include interrupting the phase currents responsive to the at least one symmetrical component harmonic current signal meeting a criterion. For example, interrupting the phase currents responsive to the at least one symmetrical component harmonic current signal meeting a predetermined criterion may include interrupting the phase currents responsive to a phase and/or a magnitude of the at least one symmetrical component harmonic current signal meeting a criterion.

In some embodiments, the at least one harmonic may include at least one odd harmonic. For example, the at least one odd harmonic may include at least one of a third harmonic and a fifth harmonic.

In some embodiments, the at least one symmetrical component harmonic current signal may include a positive sequence harmonic current signal and/or a negative sequence harmonic current signal.

According to further embodiments, generating at least one symmetrical component harmonic current signal for at least one harmonic of the phase currents responsive to the sensed phase currents may include generating at least one symmetrical component harmonic current signal for at least one of a third harmonic and a fifth harmonic, and interrupting the phase currents responsive to the symmetrical component harmonic current signal may include interrupting the phase currents responsive to a phase and/or a magnitude of the at least one symmetrical component harmonic current signal for the at least one of the third harmonic and the fifth harmonic meeting a criterion. Interrupting the phase currents responsive to a phase of the symmetrical component harmonic current signal for the at least one of the third harmonic and the fifth harmonic meeting a criterion may include interrupting the phase currents responsive to a phase and/or a magnitude of a positive sequence harmonic current signal and/or a negative sequence harmonic current signal meeting a criterion.

Further embodiments provide a circuit interruption device including at least one switch configured to interrupt phase currents, at least one current sensor configured to sense the phase currents, and a control circuit configured to generate at least one symmetrical component harmonic current signal for at least one harmonic of the phase currents responsive to the sensed phase currents and to cause the at least one switch to interrupt the phase currents responsive to the at least one symmetrical component harmonic current signal.

Still further embodiments provide methods including generating at least one symmetrical component harmonic current signal for at least one harmonic of a plurality of sensed phase currents and identifying a fault responsive to the at least one symmetrical component harmonic current signal. Identifying a fault responsive to the at least one symmetrical component harmonic current signal may include identifying the fault responsive to a phase and/or a magnitude of the at least one symmetrical component current signal meeting a criterion. Further embodiments provide apparatus and computer program product configured to perform such methods.

### BRIEF DESCRIPTION OF THE DRAWINGS

FIG. 1 is a schematic diagram illustrating a circuit interrupter apparatus according to some embodiments.

FIG. 2 is a flow chart illustrating operations of the apparatus of FIG. 1 according to further embodiments.

FIG. 3 is chart illustrating simulated behavior of third symmetrical component harmonic current signals in response to an arc fault.

FIGS. 4-8 are phasor diagrams illustrating simulated behavior of various symmetrical component harmonic current signals in response to an arc fault.

FIG. 9 is a flowchart illustrating operations of the apparatus of FIG. 1 according to further embodiments.

### DETAILED DESCRIPTION

Specific exemplary embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure Will be thorough and complete, and will fully convey the scope of the inventive subject matter to those skilled in the art. In the drawings, like numbers refer to like items. It will be understood that when an item is referred to as being “connected” or “coupled” to another item, it can be directly connected or coupled to the other item or intervening items may be present. As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, items, and/or components, but do not preclude the presence or addition of one or more other features, integers, steps, operations, items, components, and/or groups thereof.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

Some embodiments of the inventive subject matter arise from a realization that improved circuit protection in multi-phase power systems may be achieved by detecting changes in symmetrical component harmonic signals that closely correlate with generally high-impedance arc faults. Such techniques may be particularly advantageous in industrial environments with relatively high levels of ambient electrical noise that can render frequency detection-based arc fault detection less effective.

Symmetrical components are commonly used for analysis of three phase electrical power system. In phasor notation, a vector for three phase current is written as:

$${\overline{I}}_{abc} = [ \begin{matrix}{\overline{I}}_{A} \\ {\overline{I}}_{B} \\ {\overline{I}}_{C}\end{matrix} ] ,$$

The vector for the three symmetrical components is:

$${\overline{I}}_{PNO} = [ \begin{matrix}{\overline{I}}_{P} \\ {\overline{I}}_{N} \\ {\overline{I}}_{O}\end{matrix} ] ,$$

where the subscripts P, N, and 0 refer to the positive, negative, and zero sequence components.
The sequence components transformation matrix T may be defined as follows:

$$T = \frac{1}{3} [ \begin{matrix}1 & α & {α}^{2} \\ 1 & {α}^{2} & α \\ 1 & 1 & 1\end{matrix} ] ,$$

where α=e^{-j120°} is the phasor rotation operator. The symmetrical sequence currents are related to their phase quantities by:

Ī_{abc}=T⁻¹·Ī_{PNO}

The phasor rotation can be performed in any rotational reference space, so the transformation T can be used to analyze the sequence components for harmonics of interest, i.e., the transformation T can be applied to measurements of harmonics of the phase currents to yield symmetrical component signals for those harmonics.

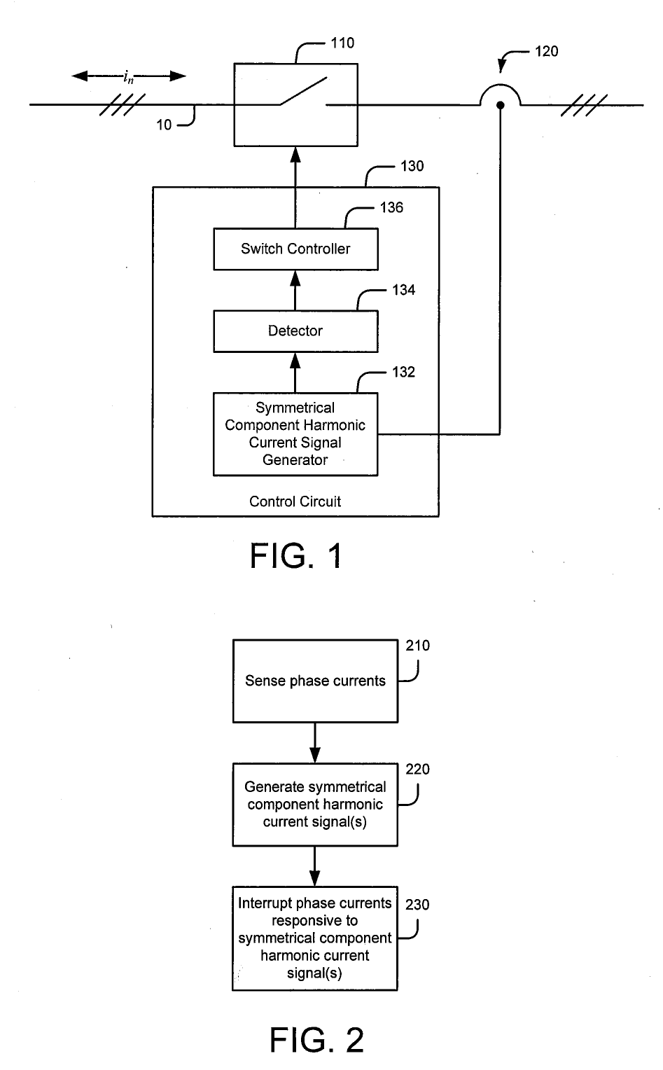

FIG. 1 illustrates a circuit interruption apparatus 100 according to some embodiments of the inventive subject matter. The apparatus 100′includes a switch 110, which is configured to interrupt phase currents iₙ through conductors 10. A current sensor 120 is configured to sense the phase currents iₙ and provides current sense signals to a control circuit 130. The control circuit 130 controls the switch 110 responsive to the current sense signals. In particular, the control circuit 130 includes a symmetrical component harmonic signal generator 132 that generates symmetrical component signals (e.g., positive, negative and zero sequence component signals) corresponding to the current sense signals for at least one harmonic of the phase currents iₙ. In some embodiments described in detail below, the harmonics may include one or more odd harmonic components, such as a third harmonic, a fifth harmonic, a seventh harmonic, etc. As explained above, these symmetrical component harmonic current signals may be generated, for example, by detecting harmonic phase current signals from the sensed phase current signals provided by the current sensor 120 and generating symmetrical component signals from these harmonic phase current signals.

A fault detector 134 is configured to detect one or more artifacts in the symmetrical component harmonic signals indicative of a fault, e.g., an arc fault. A switch controller 136 operates the switch 110 responsive to the detected artifact(s) in the symmetrical component harmonic signals meeting the criterion. For example, as described below, the fault detector 134 may detect a phase change in a positive or negative sequence harmonic component signal that meets a criterion associated with a fault, and the switch controller 136 may responsively open the switch 110 to isolate the detected fault.

It will be understood that the circuit interruption device 100 may take any of a number of different forms. For example, the circuit interruption device 100 may take the form of a multi-phase circuit breaker. The switch 110 may any of a number of different types of devices, including, but not limited to, devices using sets of mechanical contacts or devices using solid-state switches (e.g., transistors, silicon controlled rectifiers (SCRs), and the like). The control circuit 130 generally may include any of a different number of types of circuitry, including analog circuitry, digital circuitry and combinations thereof. For example, portions of the symmetrical component harmonic signal generator 132, fault detector 134 and switch controller 136 may be implemented using a microcontroller or other data processing device and associated peripheral circuitry.

FIG. 2 is a flowchart illustrating exemplary operations of the apparatus 100 according to some embodiments. While the switch 110 is closed, the phase currents iₙ are sensed and symmetrical component signals for at least one harmonic are generated (blocks 210, 220). For example, the phase currents iₙ may be sensed using current transformers (CTs), Hall Effect sensors, or the like, generating analog signals that represent the phase currents iₙ. These analog signals may be sampled by a microcontroller or other data processing device to generate phase current signal samples that from which symmetrical component values for one or more harmonics may be computed using the data processing device. These symmetrical component values may then be analyzed to detect the presence of a condition (e.g., a change in phase and/or magnitude meeting a certain criterion) indicative of a fault. Responsive to the analysis of these symmetrical component harmonic signals, the switch 110 may be operated to interrupt the phase currents iₙ (block 230).

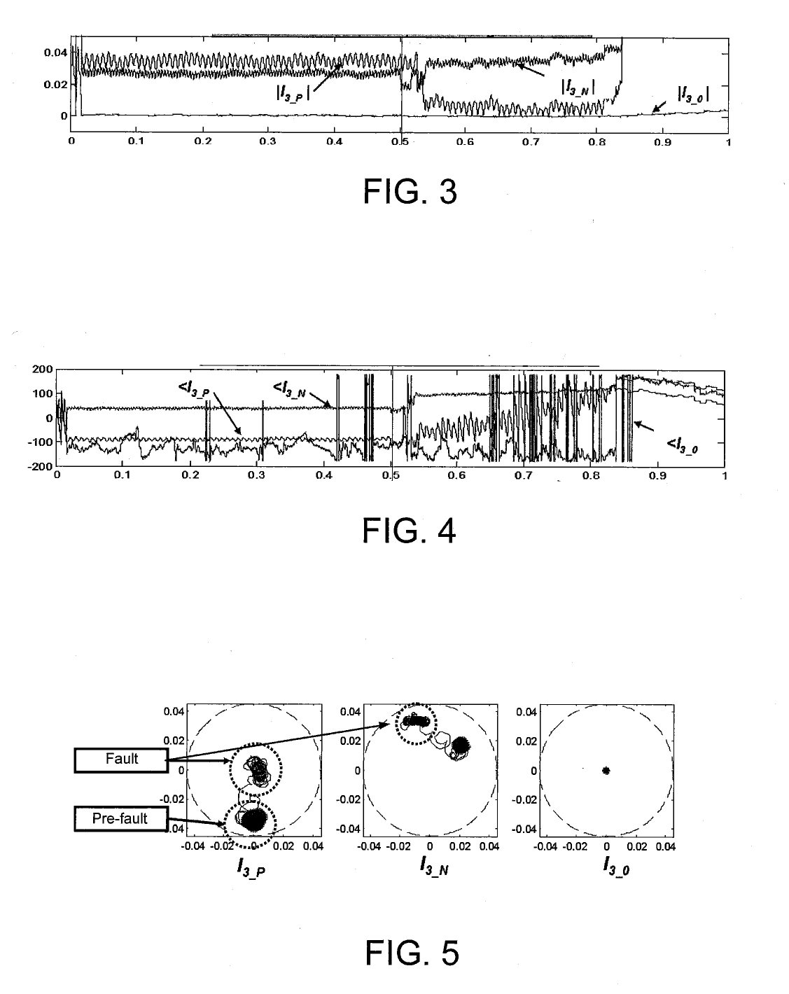

According to some embodiments, a high-impedance fault may be detected by detecting changes in odd symmetrical component harmonic signals. For example, FIGS. 3 and 4 illustrate changes in simulated third harmonic positive, negative and zero sequence current magnitude (|I₃_{_}_{P}|, |I₃_{_}_{N}|, |I₃_{_}₀|) and phase (<I₃_{_}_{P}, <I₃_{_}_{N}, <I₃_{_}_{N}) in response to a high-impedance phase-to-phase fault occurring in a three-phase system with a delta-connected load. As can be seen in FIGS. 3 and 4, significant changes in magnitude and phase occur during a time from around 0.5 sec to about 0.8 sec when a relatively high impedance phase-to-phase fault (corresponding to a typical arc fault) is present. In particular, FIG. 5 illustrates corresponding phasor diagrams for the third harmonic positive, negative and zero sequence components (I₃_{_}_{P}, I₃_{_}_{N}, I₃_{_}₀). In the illustrated example, a significant magnitude change occurs in the positive sequence component I₃_{_}_{P}), and a significant change in phase occurs in the negative sequence component I₃_{_}_{N}.

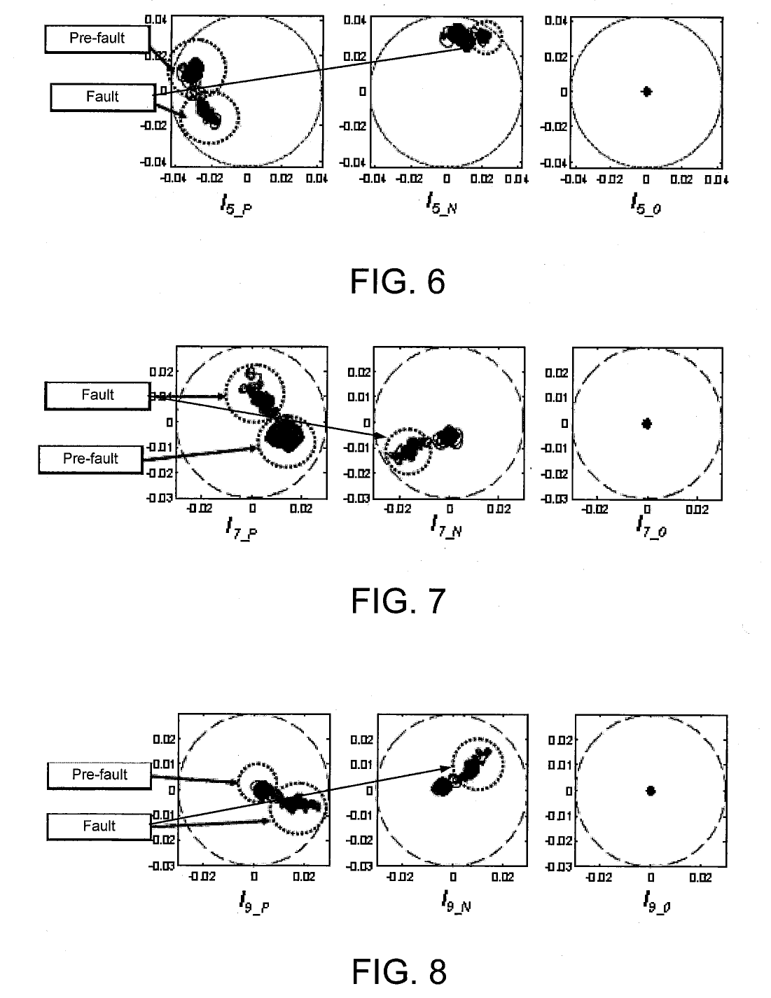

Other harmonics may exhibit similar characteristics. For example, FIG. 6 illustrates phasor diagrams for fifth harmonic positive, negative and zero sequence components I₅_{_}_{P}, I₅_{_}_{N}, I₅_{_}₀ in response to a similar fault, showing significant changes in phase for the positive sequence component I₅_{_}_{P} and for the negative sequence component I₅_{_}_{P}. FIG. 7 illustrates phasor diagrams for seventh harmonic positive, negative and zero sequence components I₇_{_}_{P}, I₇_{_}_{N}, I₇_{_}₀ in response to a similar fault, showing significant changes in phase for the positive sequence component I₇_{_}_{P} and lesser changes in phase and magnitude for the negative sequence component I₇_{_}N. FIG. 8 illustrates phasor diagrams for ninth harmonic positive, negative and zero sequence components I₉_{_}_{P}, I₉_{_}_{N}, I₉_{_}₀ in response to a similar fault, showing significant changes in magnitude for the positive sequence component I₉_{_}_{P} and the negative sequence component I₉_{_}_{N}.

Generally, the variance in magnitude and/or phase may depend on the harmonic and the nature of the fault, e.g., its location (phase-to-phase, phase-to-ground), impedance, etc. Accordingly, some embodiments may detect faults using various combinations of different types of symmetrical components (e.g., positive and/or negative) for various harmonics (e.g., third, fifth, seventh, ninth, etc.), and criteria (e.g., magnitude and/or phase). Use of information regarding multiple different harmonics and/or characteristics may improve accuracy of fault detection and reduce nuisance tripping. It is believed that detection of phase changes in positive or negative sequence components for third and fifth harmonics may provide the most accurate detection of typical high-impedance faults, but it will be appreciated that embodiments of the inventive subject matter are not limited thereto.

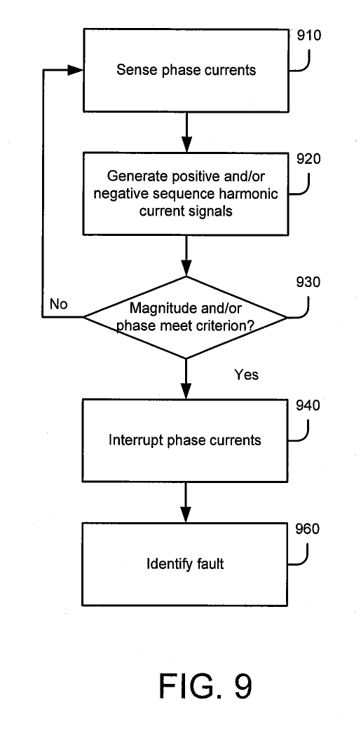

FIG. 9 illustrates operations of the circuit interrupter apparatus 100 of FIG. 1 according to further embodiments. While the switch 110 is closed, the phase currents iₙ are sensed and positive and/or negative symmetrical component harmonic current signals for a plurality of different harmonics are generated (blocks 910, 920). Magnitude and/or phase of these symmetrical component harmonic current signals may then be analyzed to detect magnitude and/or phase behavior meeting a certain criterion indicative of a fault and, responsive to this analysis, the switch 110 may be operated to interrupt the phase currents iₙ (blocks 930, 940). The analysis may include, for example, generating an aggregate metric representative of changes in magnitude and/or phase for the symmetrical component signals for the multiple harmonics and determining whether this aggregate metric meets a certain criterion. Other embodiments may involve, for example, identifying a pattern or patterns in magnitude and/or phase across multiple harmonics that highly correlate with faults, and opening the switch 110 responsive to detection of such a pattern or patterns. Such pattern recognition may be preprogrammed and/or learned in situ, such that fault recognition may be tailored to a particular application (e.g., a particular distribution system, load, etc.). Such pattern recognition may also be used to identify the type of fault detected (block 960), which may aid maintenance personnel in locating and correcting a fault condition.

In the drawings and specification, there have been disclosed exemplary embodiments of the inventive subject matter. Although specific terms are employed, they are used in a generic and descriptive sense only and not for purposes of limitation, the scope of the inventive subject matter being defined by the following claims.

That which is claimed:

1. A method of operating a circuit interruption device, the method comprising:
sensing phase currents through the circuit interruption device;
generating at least one symmetrical component harmonic current signal for at least one harmonic of the phase currents responsive to the sensed phase currents; and
interrupting the phase currents responsive to the at least one symmetrical component harmonic current signal.

2. The method of claim 1, wherein interrupting the phase currents responsive to the at least one symmetrical component harmonic current signal comprises interrupting the phase currents responsive to the at least one symmetrical component harmonic current signal meeting a criterion.

3. The method of claim 2, wherein interrupting the phase currents responsive to the at least one symmetrical component harmonic current signal meeting a predetermined criterion comprises interrupting the phase currents responsive to a phase and/or a magnitude of the at least one symmetrical component harmonic current signal meeting a criterion.

4. The method of claim 1, wherein the at least one harmonic comprises at least one odd harmonic.

5. The method of claim 4, wherein the at least one odd harmonic comprises at least one of a third harmonic and a fifth harmonic.

6. The method of claim 1, wherein the at least one symmetrical component harmonic current signal comprises a positive sequence harmonic current signal and/or a negative sequence harmonic current signal.

7. The method of claim 1:
wherein generating at least one symmetrical component harmonic current signal for at least one harmonic of the phase currents responsive to the sensed phase currents comprises generating at least one symmetrical component harmonic current signal for at least one of a third harmonic and a fifth harmonic; and
wherein interrupting the phase currents responsive to the symmetrical component harmonic current signal comprises interrupting the phase currents responsive to a phase and/or a magnitude of the at least one symmetrical component harmonic current signal for the at least one of the third harmonic and the fifth harmonic meeting a criterion.

8. The method of claim 7, wherein interrupting the phase currents responsive to a phase of the symmetrical component harmonic current signal for the at least one of the third harmonic and the fifth harmonic meeting a criterion comprises interrupting the phase currents responsive to a phase and/or a magnitude of a positive sequence harmonic current signal and/or a negative sequence harmonic current signal meeting a criterion.

9. A circuit interruption device comprising:
at least one switch configured to interrupt phase currents;
at least one current sensor configured to sense the phase currents; and
a control circuit configured to generate at least one symmetrical component harmonic current signal for at least one harmonic of the phase currents responsive to the sensed phase currents and to cause the at least one switch to interrupt the phase currents responsive to the at least one symmetrical component harmonic current signal.

10. The device of claim 9, wherein the control circuit is configured to cause the switch to interrupt the phase currents responsive to the at least one symmetrical component harmonic current signal meeting a criterion.

11. The device of claim 10, wherein the control circuit is configured to cause the switch to interrupt the phase currents responsive to a phase and/or magnitude of the at least one symmetrical component harmonic current signal meeting a criterion.

12. The device of claim 9, wherein the at least one harmonic comprises at least one of a third harmonic and a fifth harmonic.

13. The device of claim 9, wherein the at least one symmetrical component harmonic current signal comprises a positive sequence harmonic current signal and/or a negative sequence harmonic current signal.

14. The device of claim 9, wherein the control circuit is configured to generate at least one symmetrical component current signal for at least one of a third harmonic and a fifth harmonic responsive to the sensed phase currents and to interrupt the phase currents responsive to a phase and/or a magnitude of the at least one symmetrical component current signal for the at least one of the third harmonic and the fifth harmonic meeting a criterion.

15. The device of claim 14, wherein the control circuit is configured to interrupt the phase currents responsive to a phase and/or a magnitude of a positive sequence harmonic current signal or a negative sequence harmonic current signal meeting a criterion.

16. A method comprising:
generating at least one symmetrical component harmonic current signal for at least one harmonic of a plurality of sensed phase currents; and
identifying a fault responsive to the at least one symmetrical component harmonic current signal.

17. The method of claim 16, wherein identifying a fault responsive to the at least one symmetrical component harmonic current signal comprises identifying the fault responsive to a phase and/or a magnitude of the at least one symmetrical component current signal meeting a criterion.

18. The method of claim 16, wherein the at least one harmonic comprises at least one odd harmonic.

19. An apparatus configured to perform the method of claim 16.

20. A computer program product comprising a tangible non-transitory computer readable storage medium having computer readable program code embodied therein that, when executed by at least one processor, causes the at least one processor to perform the operations of claim 16.
